(19) United States
(12) Patent Application Publication
(10) Pub. No.: US 2022/0338643 A1
(43) Pub. Date: Oct. 27, 2022

(54) DYNAMIC LIGHT SIGNAGE SYSTEM FOR THE HIGHLIGHTING OF ONE OR MORE PRODUCTS IN ONE OR MORE SHOP SHELVES

(71) Applicant: Envalia, Lille (FR)

(72) Inventor: Eric RAMBOUR, Lille (FR)

(21) Appl. No.: 17/620,773

(22) PCT Filed: Jun. 19, 2020
(86) PCT No.: PCT/IB2020/055800

§ 371 Date: Dec. 20, 2021

(30) Foreign Application Priority Data
Jun. 19, 2019 (EP) 19305786.6

(51) Int. Cl. A47F 3/00; H05B 47/105; H05B 47/155; A47F 11/10; H05B 47/16

(52) U.S. Cl. CPC A47F 3/001; H05B 47/105; H05B 47/155; A47F 11/10; H05B 47/16

(57) ABSTRACT

The invention related to advertising, in particular light signage elements—typically plates or signs—which are placed or coupled to shelves/fixtures in a supermarket/shop, in order to provide information or highlight a specific product. It is therefore an object of the present a dynamic light signage system (1) for the highlighting of a product (10) in one or more shop shelves which comprises lighting means (2), the lighting means (2) being so configured that are able to define a plurality of light projection areas, each light projection area being associated with a selectable product (10) placed on said one or more shelves and lighting an area of a shelf, and a lighting means (2) control device wherein, upon detection of a command in relation to a selectable product (10), the lighting means (2) light the light projection area which is associated to the selectable product (10).

### FIELD OF THE INVENTION

The present invention is enclosed in the area of advertising, in particular light signage elements—typically plates or signs—which are placed or coupled to shelves/fixtures in a supermarket/shop, in order to provide information or highlight a specific product.

### PRIOR ART

Solutions exist in the art where the information or highlighting of a specific product is performed by a static plate, which has to be manually placed and/or configured by a human used in order to provide information on the corresponding product. Such is the case of the system of EP0557361, which provides static textual/numeric information on a product, and has specific means for coupling to a supermarket shelf.

However, not only is such information mainly static as the (re-) configuration abilities that the system provides are very limited, which leads to a highly static performance, which requires a higher intervention from a human user.

Other more developed options exist, which already include the ability to remotely actuate on the elements which are provided by the plate, as is the case of the solution of DE19715105. Yet, also such solution is highly static, and mainly based on independent devices which are not inter-relatable or operable.

The present solution innovatively overcomes such issues, by providing the ability of, with a single controller and lighting means, easily highlight one or more products while, at the same time, provide a highly reconfigurable in a very dynamic environment as is the case of supermarket/shop shelves.

### SUMMARY OF THE INVENTION

It is therefore an object of the present invention a dynamic light signage system for the highlighting of one or more products in one or more shop shelves which comprises:
lighting means, the lighting means being so configured that are able to define a plurality of light projection areas, each light projection area being associated with a selectable product placed on said one or more shelves and lighting an area of a shelf, and
a lighting means control device,
   the lighting means control device being configured to control the operation of the lighting means and to, upon detection of a command, the command being in relation to a selectable product, actuate on the lighting means to light the light projection area which is associated to the selectable product. Thus, upon the emission of a command relating to the selection of a product which is placed in a shelf, the control device of the apparatus is configured to actuate on the lighting means—which may comprise a video projector or a plurality of light sources—and which define a light projection area, thereby highlighting the corresponding (and selectable) product. The solution of the present invention allows to change the operation of parameters of the lighting means, while maintaining the same products, or to actuate simultaneously on several light projection areas. The actuation on the lighting means to light the light projection area which is associated to the selectable product may include the turning on/off of the lighting means or, alternatively or complementary, changing the colour or brightness of the lighting means.

In a preferred embodiment, the system is further configured to provide i) update of the light projection areas, such that the area of a shelf which is lit, and which corresponds to a light projection area, is definable in at least a predefined minimum light projection area, and ii) instruction of the lighting means control device on the updated relation between the area of a shelf which is lit and the corresponding light projection area. Such provides an eased and highly reconfigurable solution, particularly relevant in an ever changing environment as is the case of a supermarket or shop shelf, in which products are frequently moved or replaced.

Preferably, the command results from the interaction with a user relating to the selection of the product, wherein the interaction preferably includes a manual or automatic selection of a product. Thus, the user may either select a selectable product specifically or, alternatively, the device may be configured to choose a product automatically based on a selection of the user, and correspondingly highlight the product.

Advantageously, the system further comprises a light management system comprising a database which contains the relation between each light projection area and a selectable product, the light management system being preferably configured to perform said i) update of the light projection areas and ii) instruction of the lighting means control device. It therefore provides a suitable basis for the dynamic and reconfigurable character of the system of the present invention.

Since a shelf may contain several sections, or the application may be directed to a rack comprising several shelves, the lighting means control device is configured to operate simultaneously on lighting means corresponding to more than one light projection areas, preferably simultaneously turning on or off lighting corresponding to more than one light projection areas. It therefore provides for the highlighting of several products, which may for instance be related in terms of its usefulness to a user/client.

It is also an object of the present invention a shop shelf comprising the light signage system of the present invention, in any of its embodiments.

In addition, it is further an object of the present invention a shop rack comprising a plurality of shelves, wherein at least one of such shelves is a shop shelf as described in the previous paragraph.

### DESCRIPTION OF FIGURES

FIG. 1—front view of a representation of the system (1) of the present invention according to a first embodiment, in which the lighting means consist of a plurality of light sources (2), in particular groups of light sources (2) being associated in light projection areas (3), and three light projection areas (3) being simultaneously turned on (schematically represented by white lamps).

FIG. 2—front view of a representation of the system (1) of the present invention according to the first embodiment, as of FIG. 1, in which case the turning on of the three light projection areas (3) being a consequence of a selection in a fixed or portable device (20), in which a specific selection was performed.

FIG. 3—side view of a representation of the system (1) of the present invention according to the first embodiment, as of FIGS. 1 and 2, showing the position of a customer/user in relation to a product (10) placed in a shelf (5) and the system (1). The lighting means (2)/light sources (2) highlight the product, both by means of direct lighting and indirect lighting, as the enclosure (4) comprises a reflective surface (6) within it. Moreover, a frontal section of the enclosure comprises a product description sign (7), wherein the reflective surface (6) is such that it is selective, such that part of the light from the light source is reflected onto the product and another part of the light crosses the reflective surface (6) and reaches a user. The product description sign (7) is also partly transparent, in order for such light to reach the user.

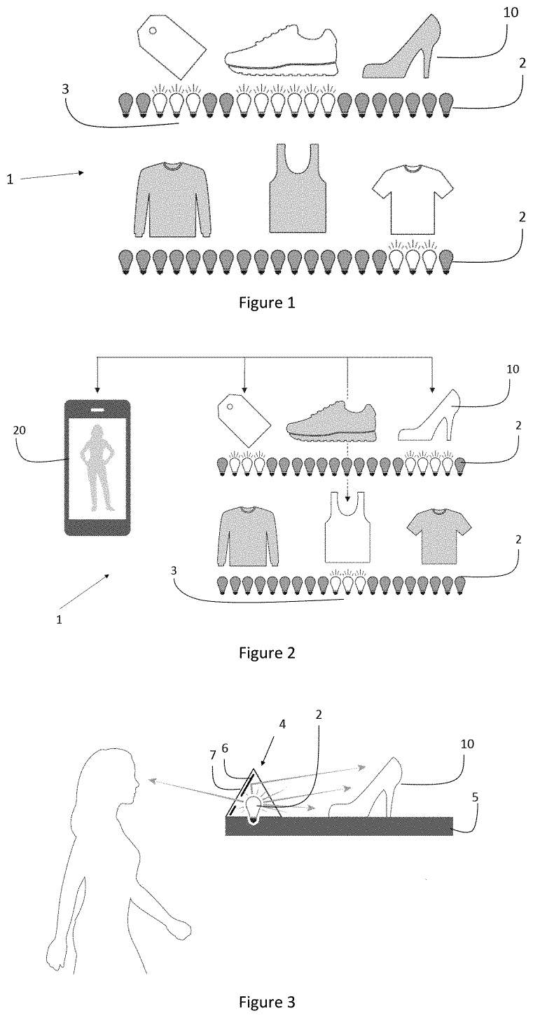

### DETAILED DESCRIPTION

The more general and advantageous configurations of the present invention are described in the Summary of the invention. Such configurations are detailed below in accordance with other advantageous and/or preferred embodiments of implementation of the present invention.

In another inventive aspect of the system (1) of the present invention, the lighting means control device is further configured to control the lighting means based on one or more parameters, such one or more parameters consisting of:
time of operation, such that the lighting for each light projection area (3) is turned on for a predefined period of time, and subsequently turned off,
light intensity, such that the lighting for each light projection area (3) has a specific light intensity and/or changing light intensity, and
   the light management system (1) being optionally further configured to update said one or more parameters of operation.

In a first specific embodiment of the system (1) of the present invention, the lighting means comprise a plurality of light sources (2) so arranged that each one or more light sources (2) defines a light projection area (3), and the lighting means control device being configured to control the operation of each of the plurality of light sources (2) independently. The ability of the lighting means control device to actuate independently on each light source and the association of light sources (2) into light projection areas (3) provides a possible eased and highly reconfigurable solution, particularly relevant in an ever changing environment as is the case of a supermarket or shop shelf (5), in which products are frequently moved or replaced. Preferably, more than one of the light sources (2) defines a light projection area (3), and more than one light projection areas (3) are defined. In particular, the system (1) comprises one or more groups of sequentially arranged light sources (2), such sequential arrangement preferably being linear, and each two or more light sources (2) which define a same light projection area (3) being part of a same group and adjacently arranged.

Yet under the first embodiment, each group of light sources (2) comprises a reflective surface (6), the reflective surface (6) and the plurality of light sources (2) of a same group being so arranged that light from such light sources (2) is directed to one or more products to be lit by means of i) light reflected on such surface and redirected to said one or more products and ii) directly from such light sources (2). Such reflective surface (6) therefore provides for indirect lighting of the product (10) to be highlighted.

In addition, each group of light sources (2) may further comprise an enclosure (4), such light sources (2) of a same group and the reflective surface (6) being arranged within the enclosure (4), the enclosure (4) comprising at least one transparent surface, wherein said direct and redirected light crosses the transparent surface, preferably the plurality of light sources (2) being arranged along an inner surface of a face of the enclosure (4), such face of the enclosure (4) being at least partially transparent. Therefore, the reflective surface (6) and the transparent surface provide for indirect illumination of the product (10)— in a so-called rear portion of the apparatus —, while the at least partially transparent surface associated with the plurality of light sources (2) provides for the illumination of a so-called frontal portion of the apparatus, which is suitable to be normally facing a user, all with a single set of light sources (2).

In a specific embodiment, the reflective surface (6) is such that it is selective, such that part of the light from the light source is reflected onto the product and another part of the light crosses the reflective surface (6) and reaches a user, as of FIG. 3.

Still within the terms of the first embodiment, each group of light sources (2) further comprises at least one product description sign (7) corresponding to a product (10) and arranged in a corresponding enclosure (4), specifically oppositely arranged with regard to the inner surface in which the light sources (2) of such group are arranged and, preferably, each enclosure (4) has a triangular prism shape, defined by the surface comprising the plurality of light sources (2), the reflective surface (6) and the transparent surface. It consists of a simple and eased way to provide the apparatus in a shelf (5), while maintaining the functionalities of rear lighting through the reflective surface (6) and frontal lighting through the at least partially transparent surface, which thereby also highlights the product description sign (7).

Where the first embodiment comprises a product description sign (7) and a reflecting surface (6), the product description sign (7) is also partly transparent, in order for the light which crosses the reflecting surface (6) to reach the user, as of FIG. 3.

In addition, each group of light sources (2) may comprise at least one strip of light-emitting diodes, a plurality of light projectors and/or a plurality of pixels and, optionally, such light sources (2) being omnidirectional, semi-directional or projected.

Still within the terms of the first embodiment, the dynamic light signage system may further comprise a central controller board and one or more auxiliary controller boards, each of the auxiliary controller boards being configured to control one or more groups of light sources (2). The central controller board is configured to actuate on each auxiliary controller board and thereupon each auxiliary controller board actuates on the corresponding groups of light sources (2) that it controls. Preferably, in such case the light sources (2) consist of light-emitting diodes. Such configuration provides that the system behaves as one entity (only one—central—controller board receiving commands), therefore being a single system on the functional side, while on the physical side it consists of a modular and expandable system—easily adding additional auxiliary controller boards and corresponding light sources (2)—, thereby providing expandability—additional auxiliary controller boards and corresponding group or groups of light sources (2) may be added —, and reducing wiring between auxiliary controller boards and corresponding light sources (2), as auxiliary controller boards can be closer to the shelves that they drive.

Moreover, and with regard to the (re)configuration of one or more parameters, the first embodiment further provides coordination effects, such that the on and off times of each of the light sources (2) of a light projection area (3) are dependent on the on and off times of the other light sources (2) of a same group or light projection area (3), optionally each light source being turned on after another light source having been turned off.

In a second embodiment of the system (1) of the present invention, alternative to the first embodiment, the lighting means comprise at least one video projector, the video projector being configured to light an area which contains one or more shelves (5). It therefore provides another, more versatile, option, in which the lighting means are entirely separated from the shelf (5), and create the light projection areas (3) by means of providing light to such area or areas.

Regarding both first and second embodiments, the system (1) of the present invention may further comprise a fixed or portable device (20), the fixed or portable device (20) comprising the interface means, such as a fixed tablet, the fixed or portable device (20) being configured to communicate with the lighting means control device and/or with light management system (1) and issuing said command. Thus, for instance by means of an app, each apparatus is controllable, by means of the selection of a product (10) in the app, such product (10) being associated to a particular light projection area (3). In the embodiment in which the fixed or portable device is fixed, it is in particular fixed to the system or to a shelf which comprises the system.

In addition, and as regards the manual or automatic selection of a product, the following three options is possible (in a non-limitative fashion):
highlighting a product in relation to a selection of the user, namely based on information displayed on an interactive equipment (fixed/mobile) while a user uses it (driven interactive usage), or
highlighting a product based on an automatic selection performed by the system, such as an automatic slideshow (driven non-interactive usage), or
highlighting a product based on an automatic selection performed by the system, such as pre-programed patterns which sequentially highlight products (stand-alone usage).

As will be clear to one skilled in the art, the present invention should not be limited to the embodiments described herein, and a number of changes are possible which remain within the scope of the present invention.

Of course, the preferred embodiments shown above are combinable, in the different possible forms, being herein avoided the repetition all such combinations.

1. A dynamic light signage system (1) for the highlighting of one or more products (10) in one or more shop shelves (5) characterised in that it comprises:
lighting means, the lighting means being so configured to define a plurality of light projection areas (3), each light projection area (3) being associated with a selectable product (10) placed on said one or more shelves (5) and lighting an area of a shelf (5), and
a lighting means control device,
the lighting means control device being configured to control the operation of the lighting means and to, upon detection of a command, the command being in relation to the selectable product (10), actuate on the lighting means to light the light projection area (3) which is associated to the selectable product (10), wherein the system (1) is further configured to provide i) update of the light projection areas (3), such that the area of a shelf (5) which is lit, and which corresponds to a light projection area (3), is definable in at least a predefined minimum light projection area (3), and to provide ii) instruction of the lighting means control device on the updated relation between the area of a shelf (5) which is lit and the corresponding light projection area (3).

2. A dynamic light signage system (1) according to claim 1 wherein the command results from the interaction with a user relating to the selection of the product (10), wherein the interaction preferably includes a manual or automatic selection of a product (10).

3. A dynamic light signage system (1) according to claim 2 wherein the system comprises a light management system (1) comprising a database which contains the relation between each light projection area (3) and a selectable product (10), the light management system (1) being preferably configured to perform said i) update of the light projection areas (3) and ii) instruction of the lighting means control device.

4. A dynamic light signage system (1) according to claim 1 wherein the lighting means control device is configured to operate simultaneously on lighting means corresponding to more than one light projection areas (3), preferably simultaneously turning on or off lighting corresponding to more than one light projection areas (3).

5. A dynamic light signage system (1) according to claim 3 wherein the lighting means control device is further configured to control the lighting means based on one or more parameters, such one or more parameters consisting of:
time of operation, such that the lighting for each light projection area (3) is turned on for a predefined period of time, and subsequently turned off,
light intensity, such that the lighting for each light projection area (3) has a specific light intensity and/or changing light intensity, and
the light management system (1) being optionally further configured to update said one or more parameters of operation.

6. A dynamic light signage system (1) according to claim 1 wherein the lighting means comprise a plurality of light sources (2) so arranged that each one or more light sources (2) defines a light projection area (3), and the lighting means control device being configured to control the operation of each of the plurality of light sources (2) independently.

7. A dynamic light signage system (1) according to claim 6 wherein the system comprises one or more groups of sequentially arranged light sources (2), such sequential arrangement preferably being linear, and each two or more light sources (2) which define a same light projection area (3) being part of a same group and adjacently arranged.

8. A dynamic light signage system (1) according to claim 7 wherein each group of light sources (2) comprises a reflective surface (6), the reflective surface (6) and the plurality of light sources (2) of a same group being so arranged that light from such light sources (2) is directed to one or more products to be lit by means of i) light reflected on such surface and redirected to said one or more products and ii) directly from such light sources (2), and, preferably, each group of light sources (2) further comprises an enclosure (4), such light sources (2) of a same group and the reflective surface (6) being arranged within the enclosure (4), the enclosure (4) comprising at least one transparent surface, wherein said direct and redirected light crosses the transparent surface, preferably the plurality of light sources (2) being arranged along an inner surface of a face of the enclosure (4), such face of the enclosure (4) being at least partially transparent.

9. A dynamic light signage system (1) according to claim 8 wherein each group of light sources (2) comprises at least one strip of light-emitting diodes, a plurality of light projectors and/or a plurality of pixels and, optionally, such light sources (2) being omnidirectional, semi-directional or projected.

10. A dynamic light signage system (1) according to claim 1 wherein the lighting means comprise at least one video projector, the video projector being configured to light an area which contains one or more shelves (5).

11. A dynamic light signage system (1) according to claim 10 wherein the video projector is further configured such that the lighting of a light projection area (3) corresponds to an area which the video projector is able to light with a colour which is lighter than a non-lit area.

12. A dynamic light signage system (1) according to claim 3 wherein it further comprises a fixed or portable device (20), the fixed or portable device (20) comprising interface means and the fixed or portable device (20) being configured to communicate with the lighting means control device and/or with light management system (1) and issuing said command.

13. A shop shelf (5) comprising a dynamic light signage system (1) for the highlighting of one or more products (10) in one or more shop shelves (5), the dynamic light signage system (1) comprising:
lighting means, the lighting means being so configured to define a plurality of light, projection areas (3), each light projection area (3) being associated with a selectable product (10) placed on said one or more shelves (5) and lighting an area of a shelf (5), and
a lighting means control device,
the lighting means control device being configured to control the operation of the lighting means and to, upon detection of a command, the command being in relation to the selectable product (10), actuate on the lighting means to light the light projection area (3) which is associated to the selectable product (10), wherein the system (1) is further configured to provide i) update of the light projection areas (3), such that the area of a shelf (5) which is lit, and which corresponds to a light projection area (3), is definable in at least a predefined minimum light projection area (3), and to provide ii) instruction of the lighting means control device on the updated relation between the area of a shelf (5) which is lit and the corresponding light projection area (3).

14. A shop rack comprising a plurality of shelves (5), wherein at least one of such shelves (5) is a shop shelf (5) comprising a dynamic light signage system (1) for the highlighting of one or more products (10) in one or more shop shelves (5), the dynamic light signage system (1) comprising:
lighting means, the lighting means being so configured to define a plurality of light protection areas (3), each light projection area (3) being associated with a selectable product (10) placed on said one or more shelves (5) and lighting an area of a shelf (5), and
a lighting means control device,
the lighting means control device being configured to control the operation of the lighting, means and to, upon detection of a command, the command being in relation to the selectable product (10), actuate on the lighting means to light the light projection area (3) which is associated to the selectable product (10), wherein the system (1) is further configured to provide i) update of the light projection areas (3), such that the area of a shelf (5) which is lit, and which corresponds to a light projection area (3), is definable in at least a predefined minimum light projection area (3), and to provide ii) instruction of the lighting means control device on the updated relation between the area of a shelf (5) which is lit and the corresponding light projection area (3).
